(19) United States
(12) Patent Application Publication
(10) Pub. No.: US 2025/0167491 A1
(43) Pub. Date: May 22, 2025

(54) ELECTRICAL DEVICE

(71) Applicant: WAGO Verwaltungsgesellschaft mbH, Minden (DE)

(72) Inventor: Lars BINNER, Melle (DE)

(73) Assignee: WAGO Verwaltungsgesellschaft mbH, Minden (DE)

(21) Appl. No.: 19/035,774

(22) Filed: Jan. 23, 2025

Related U.S. Application Data
(63) Continuation of application No. PCT/EP2023/070555, filed on Jul. 25, 2023.

(30) Foreign Application Priority Data
Jul. 25, 2022 (DE) 10 2022 118 547.8

(51) Int. Cl. H01R 13/635; H01H 50/04

(52) U.S. Cl. CPC H01R 13/635; H01H 50/048

(57) ABSTRACT

An electrical device having a receiving apparatus for releasably accommodating an electrical and/or electronic component, in particular a relay module or an electrical circuit. The electrical device has a trigger unit for performing a triggering operation on the component. The trigger unit has a trigger pusher that has an actuation surface for actuating the trigger pusher. During a triggering operation, the component, by actuation of the actuation surface, is at least partially removable from the receiving apparatus as a result of a force exerted on the component by the trigger pusher.

This nonprovisional application is a continuation of International Application No. PCT/EP2023/070555, which was filed on Jul. 25, 2023, and which claims priority to German Patent Application No. 10 2022 118 547.8, which was filed in Germany on Jul. 25, 2022, and which are both herein incorporated by reference.

### BACKGROUND OF THE INVENTION

### Field of the Invention

The invention relates to an electrical device having a receiving apparatus for releasably accommodating an electrical and/or electronic component, in particular a relay module or an electrical circuit, wherein the electrical device has a trigger unit for performing a triggering operation on the component, wherein the trigger unit has a trigger pusher that has an actuation surface for actuating the trigger pusher, wherein during a triggering operation the component, by actuation of the actuation surface, is at least partially removable from the receiving apparatus as a result of a exerted on the component by the trigger pusher.

### Description of the Background Art

An electrical device having such a trigger mechanism is known from EP 3 439 011 B1, which corresponds to US 2019/0044282, which is incorporated herein by reference.

### SUMMARY OF THE INVENTION

It is therefore an object of the present invention to provide an electrical device having a universally usable trigger unit.

For an electrical device of the type stated at the outset, this object is achieved in that the component is insertable into the receiving apparatus from a first housing side of the housing of the electrical device, and via the actuation the actuation surface is actuatable from a second housing side of the housing of the electrical device. The invention has the advantage that the novel principle of the trigger unit proposed here is also as suitable for other housing designs as proposals from the prior art. In particular, it is possible to associate the actuation of the trigger pusher over the actuation surface with a different housing side, and to accordingly perform the actuation of the trigger pusher there instead of at the housing side at which the component is insertable into the receiving apparatus. In many cases, the actuation of the actuation surface may thus be made be more ergonomic, or may be more favorably combined with other requirements for the electrical device, for example with a housing side that is provided for the connection of cabling. Thus, for example, the first housing side may be a housing side that is not provided for connecting the cabling of the electrical device, and the second housing side may be a housing side that is provided for connecting the cabling of the electrical device.

The trigger pusher may be a one-part or multi-part component. At least a portion of the trigger pusher may be displaceably supported, for example linearly displaceably supported. For example, the trigger pusher may have multiple segments, for example multiple segments situated one behind the other in the displacement direction. The segments of the trigger pusher may be loosely situated one behind the other as separate components. Segments may also be articulatedly connected to one another via a hinge. As the result of a one-part design, the trigger pusher may be implemented particularly economically and robustly.

The second housing side is advantageously a different housing side than the first housing side. The force to be applied to the actuation surface for actuating the trigger pusher may advantageously be applied in a direction that is orthogonal with respect to the planar extension of the second housing side. The force for actuating the trigger pusher may be applied, in a manner of speaking, in a movement that is directed toward the second housing side. Via the trigger pusher, the force for a triggering operation may be transmitted from the bottom side of the receiving apparatus to the component. For example, the housing may have electrical connections, for example plug connections, below the receiving apparatus which may be contacted by the component that is inserted into the receiving apparatus.

The receiving apparatus for releasably accommodating an electrical and/or electronic component may have a shaft-shaped design, for example, or some other shape. With a shaft-shaped design, the receiving apparatus may be designed as a receiving shaft. This also analogously applies for the receiving apparatus mentioned below.

The trigger unit may be configured only to release the electrical and/or electronic component accommodated in the receiving apparatus. Via the trigger pusher, the component may be at least partially removable or pushable from the receiving apparatus.

The trigger unit may also be designed for carrying out an ejection operation for the component. In this case, the trigger unit may be designed as an ejection unit. The trigger pusher may then be designed as an ejection pusher. Via the ejection pusher, the component may be at least partially ejectable or pushable from the receiving apparatus.

The trigger pusher may be actuatable at its actuation surface by use of an automatic apparatus or a tool. The trigger pusher may also be actuatable directly by manual actuation, or indirectly via a tool. The actuation of the trigger pusher at the actuation surface may take place via a tensile force or a pressure force. In the case of actuation via a pressure force, the actuation surface may be designed as a pressure actuation surface. In one advantageous embodiment, the trigger pusher acts on the component to be triggered via a pressure force, i.e., the component is at least partially removable from the receiving apparatus via a pressure force that is exerted on the component by the trigger pusher.

The second housing side can be a housing side of the housing of the electrical device facing away from the first housing side or situated at an angle thereto. This allows great flexibility in the design of the housing and the integration of the trigger unit into the housing. For example, the angle between the first housing side and the second housing side may be essentially 90°.

As a result of the trigger pusher, during a triggering operation on the component a force applied to the actuation surface in a first direction is deflected into a force that acts in a second direction on the component to be ejected, the first direction differing from the second direction. This allows advantageous deflection of the direction of the effective force exerted on the actuation surface into the force that is transmitted to the component to be ejected by the trigger pusher. For example, an angle in the range of 45° to 135°, in particular an essentially right angle, may be formed between the first direction and the second direction. In an example, the angle may be in the range of 75° to 105°.

The trigger pusher can have at least one first segment and one second segment, wherein the first segment includes the actuation surface, and the second segment includes a section, in particular an end-side section, which during the triggering operation comes into contact with the component to be ejected. Such segmentation provided in the force transmission direction of the trigger pusher has the advantage that the trigger pusher may be adapted to many different types of electrical devices and various housing designs, using simple means. In particular, one or more further parts of the trigger pusher may be situated between the first segment and the second segment. In addition, it is possible for one or more further segments to be situated behind the second segment, viewed from the first segment, with which further functions of the trigger pusher may be implemented.

The first and second segments can be articulatedly connected to one another via at least one hinge. A simple and reliably functioning mechanism for releasing the component may be provided in this way. For example, the trigger pusher may be designed according to the toggle lever principle. The at least one hinge may be designed as a film hinge, for example. The film hinge may be present as an additional component or may be formed by the material of the trigger pusher. For example, the first and second segments may be integrally joined to one another via the at least one hinge. The first segment does not have to be directly connected to the second segment via the at least one hinge, but instead may optionally be connected via a further component situated in between, for example the deflection lever explained below.

If the trigger pusher is designed as a one-part component, for example as an injection-molded component, the at least one hinge may be formed as a thin material bridge between the first segment and the second segment, using the injection-molded material.

The first segment can be coupled to the second segment via a swivelably supported deflection lever. By use of such a deflection lever, the trigger mechanism may be flexibly adapted to various housing designs. As a result of the design of the deflection lever, it is possible to perform an appropriate power transmission from the force that is applied to the actuation surface into the force that is exerted on the component to be ejected. For example, the deflection lever may be designed with a force arm and a load arm that have the same length. Alternatively, the force arm may be longer than the load arm or shorter than the load arm.

The deflection lever with its force arm may be articulatedly connected to the first segment via a hinge, and/or at its load arm may be articulatedly connected to the second segment via a further hinge. The hinges may be designed as film hinges, in particular as integrally joined hinges. The film hinge may be present as an additional component or may be formed by the material of the trigger pusher.

The deflection lever may be swivelably supported via a swivel bearing, for example. The swivel bearing may be formed, for example, with a bearing axis that passes through the deflection lever, and/or by one or more bearing pins that laterally protrude from the deflection lever and that are rotatably supported in a pin receptacle.

The trigger pusher can have at least one third segment that is articulatedly connected to the second segment via at least one hinge. In this case, the second segment may be situated between the first segment and the third segment in the effective force direction. The third segment may include a section, in particular an end-side section, which during the triggering operation comes into contact with the component to be ejected. The component to be ejected may thus be pushed even more efficiently from the receiving apparatus. In particular, during the triggering operation the second and third segments may cooperate in such a way that both segments push against the component to be ejected, and this component is thus pushed out of the receiving apparatus at two spaced-apart locations.

The trigger pusher can have at least one third segment that is swivelably supported on a swivel bearing at an area facing away from the second segment. Via a third segment designed in this way, together with the second segment it is also possible for the component that is to be ejected to be pushed out of the receiving apparatus. As a result of the swivel bearing of the third segment, the third segment is securely supported with respect to the forces that occur, and is easily swivelable. In this case the third segment may be separate from the second segment, i.e., not connected thereto via a hinge, or as explained above may be articulatedly connected to the second segment via at least one hinge. The swivel bearing may be formed, for example, with a bearing axis that passes through the third segment, and/or by one or more bearing pins that laterally protrude from the third segment and that are rotatably supported in a pin receptacle.

The electrical device can have a further receiving apparatus for releasably accommodating a further electrical and/or electronic component, in particular a relay module or an electrical circuit, the electrical device having a further trigger unit for performing a triggering operation on the further component, the further trigger unit including a further trigger pusher that has an actuation surface for actuating the further trigger pusher, wherein during a triggering operation the further component, by actuation of the actuation surface, is at least partially removable from the further receiving apparatus as a result of a force exerted on the component by the further trigger pusher, wherein via the actuation the actuation surface is actuatable from the second housing side of the housing of the electrical device. This has the advantage that reliable removal of the particular component is possible via the associated trigger unit, even for fairly complex electrical devices in which multiple electrical and/or electronic components are to be accommodated in respective receiving apparatuses.

The further component may be insertable into the further receiving apparatus from the first housing side of the housing of the electrical device, in particular only from the first housing side. The actuation surface of the trigger pusher and the actuation surface of the further trigger pusher may be designed as a shared actuation surface. Alternatively, the further trigger pusher may have a further actuation surface that is present in addition to the actuation surface of the trigger pusher that is separate therefrom. The further trigger unit may have a design that is identical or similar to the first-mentioned trigger unit. In particular, the further trigger unit may have one, multiple, or all of the described features of the trigger unit.

The further receiving apparatus can be situated farther away from the second housing side than the receiving apparatus, or as a whole is situated behind the receiving apparatus as viewed from the second housing side. This allows the electrical and/or electronic component and the further electrical and/or electronic component to be accommodated in a staggered manner one behind the other. For a segmented design of the trigger pusher and of the further trigger pusher, for example the first segment of the further trigger pusher may be longer than the first segment of the trigger pusher. The remaining features of the trigger pushers may be identical or comparable.

For example, over its longitudinal extension (in the displacement direction) or at least over the longitudinal extension of the first segment, the trigger pusher may have a predominantly uniform cross-sectional size and cross-sectional shape, for example a rectangular cross-sectional shape. The trigger pusher may have a different shape at its ends, for example to form the actuation surface. For example, at the actuation surface a depression, for example in the form of a groove, may be present at which a tool may be securely placed in order to reliably transmit the force for actuating the trigger pusher.

The trigger pusher, at least in places, can be displaceably supported on one or more bearing elements. Via a bearing contour formed in this way, the trigger pusher is supported at least flatly and/or at certain points, and is thus securely supported during the displacement movement of a triggering operation. The bearing elements may be designed, for example, as an apparatus or a section of an apparatus, which likewise is curved in an arch. The bearing elements may, for example be made of the material of the housing of the electrical device, for example by forming them in one piece in an injection molding process.

At an end facing away from the actuation surface, the trigger pusher can have an end section that forms a plunger, via which the component is at least partially removable from the receiving apparatus. The component may thus be reliably and at the same time gently removed from the receiving apparatus. For example, the plunger may have a rounded contour so that damage to the component during the triggering operation is avoided.

The component can be insertable into the receiving apparatus only from the first housing side. This has the advantage that the insertion of the component into the receiving apparatus is simplified for the user, since a certain insertion direction is specified by the shape of the housing.

The actuation surface can be actuatable by the actuation only from the second housing side. This has the advantage that the actuation of the trigger pusher has a design that is easy and straightforward for the user, since the trigger pusher can actuate the actuation surface only at a specified location. For example, the trigger pusher or at least the actuation surface may have a surface that contrasts strongly with the surface of the second housing side, for example by use of a much different color.

At the second housing side, the housing can have an opening through which the trigger pusher is actuatable at its actuation surface and/or through which the trigger pusher protrudes from the housing. This likewise allows simple operation of the trigger mechanism by the user. Depending on the design, even in the unactuated state the actuation surface may be situated slightly inside the housing, i.e., behind the surface of the second housing side, or may protrude from the housing at the second housing side.

Further scope of applicability of the present invention will become apparent from the detailed description given hereinafter. However, it should be understood that the detailed description and specific examples, while indicating preferred embodiments of the invention, are given by way of illustration only, since various changes, combinations, and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 shows an electrical device with a trigger unit in the unactuated state,

FIG. 2 shows the electrical device according to FIG. 1 with the trigger unit in the actuated state,

FIG. 3 shows a trigger pusher of the electrical device according to FIG. 1,

FIG. 4 shows an electrical device with a further embodiment of a trigger unit in the unactuated state,

FIG. 5 shows the electrical device according to FIG. 4 with the trigger unit in a first actuated state,

FIG. 6 shows the electrical device according to FIG. 4 with the trigger unit in a second actuated state,

FIG. 7 shows an electrical device with a further embodiment of a trigger unit in the unactuated state,

FIG. 8 shows the electrical device according to FIG. 7 with the trigger unit in the actuated state,

FIG. 9 shows a trigger pusher of the electrical device according to FIG. 7,

FIG. 10 shows a further trigger pusher of the electrical device according to FIG. 7,

FIG. 11 shows an electrical device with a further embodiment of a trigger unit in the unactuated state, and

FIG. 12 shows a trigger pusher of the electrical device according to FIG. 11.

### DETAILED DESCRIPTION

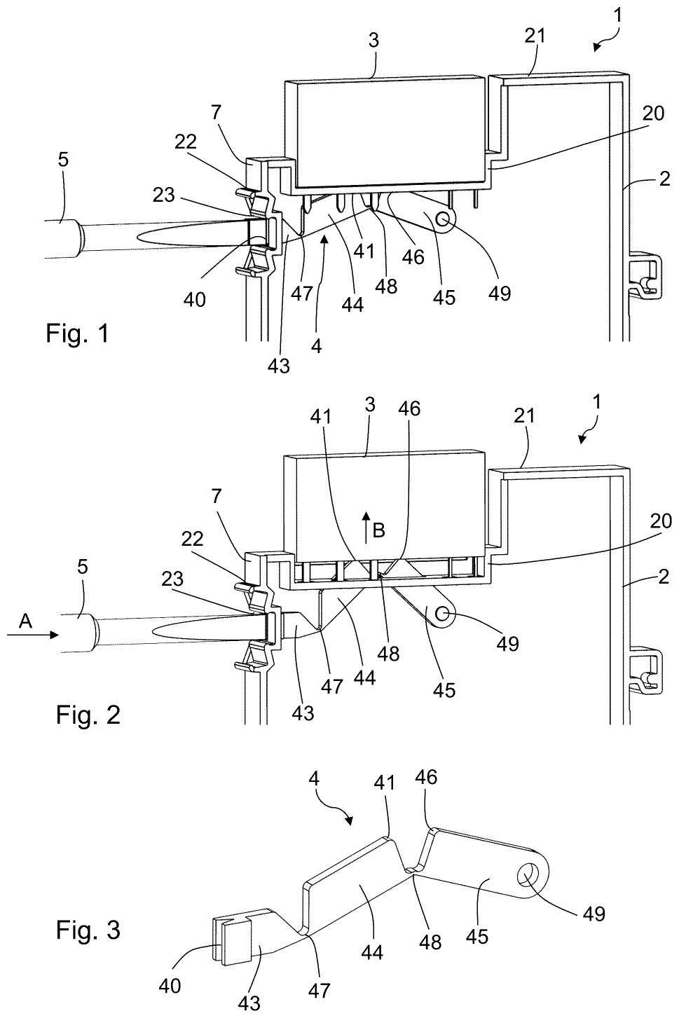

FIG. 1 shows an electrical device 1 with a housing 2 that is illustrated in a partially open perspective view. The housing 2 has a first housing side 21, and a second housing side 22 that is situated with respect to same at an angle of approximately 90°. A receiving apparatus 20 for releasably accommodating an electrical and/or electronic component 3 is present in the area of the first housing side 21. For example, the housing 2 may have electrical plug connections below the receiving apparatus 20 which may be contacted by the component 3 that is inserted into the receiving apparatus 20. It is apparent that the receiving apparatus 20 is shaped in such a way that the component 3 is insertable into the receiving apparatus 20 only from the first housing side 21.

The second housing side is a side of the housing 2 having connection options for connecting electrical lines, for example in the form of spring-loaded clamping connections. The second housing side may have identification areas 7 that may be provided with an inscription, for example.

The electrical device 1 has a trigger unit for performing a triggering operation on the component 3. During a triggering operation, the component 3 is moved out of the receiving apparatus 20 by the trigger unit. The trigger unit has a trigger pusher 4.

At an end that is directed toward the second housing side 22, the trigger pusher 4 has an actuation surface 40 that is used to actuate the trigger pusher via a force. At the other end, the trigger pusher 4 has an end section which forms a plunger 41, and which may be brought into contact with the bottom side of the component 3 and which is used for removing the component 3 from the receiving apparatus 20. The trigger pusher 4 is used to transmit the force, applied to the actuation surface 40, to the plunger 41. The direction of action A of the force that is applied to the actuation surface 40 is deflected into the direction of action B of the force that is applied by the plunger 41 to the component 3 to be ejected.

In FIG. 1, in which the trigger pusher 4 is not yet actuated by a tool 5 at the actuation surface 40, it is apparent that the trigger pusher 4 protrudes slightly from the housing 2 through an opening 23 that is formed at the second housing side 22. If the trigger pusher 4 is now acted on with a force via the tool 5 at the actuation surface 40, as shown in FIG. 2, the actuation surface 40 migrates slightly into the housing 2 until it is situated behind the surface of the second housing side 22. The corresponding curved displacement movement is transmitted to the plunger 41 via the trigger pusher 4, as a result of which the component 3 is pushed out of the receiving apparatus 20 by a force. The component 3 does not have to pushed completely from the receiving apparatus 20; rather, it is sufficient when the mechanical retaining forces of the component 3 are reduced enough so that the component can be removed there with little effort.

The embodiments of the invention described below are the same with regard to their operating principle. There are differences in particular in the design of the individual trigger pushers 4.

In the embodiment in FIGS. 1 and 2, the trigger pusher 4 is divided into three segments 43, 44, 45 in the longitudinal direction. A first segment 43 is accessible from the second housing side 22, and in the area of the opening 23 has the actuation surface 40 of the trigger pusher 4. The first segment 43 is followed by a second segment 44, which is followed by a third segment 45. At the end facing away from the first segment 43, the second segment 44 has an end section 41 which during the triggering operation presses against the component 3 to be ejected. This end section 41 is also referred to as a plunger. The third segment 45 has a comparable section 46 which during the triggering operation comes into contact with the component 3 to be ejected. In an area remote from the section 46, the third segment is swivelably supported, for example via a swivel bearing 49.

When the force is applied to the actuation surface 40 via the tool 5, the force is transmitted from the first segment 43 to the second segment 44, and from the second segment 44 to the third segment 45. As a result, the sections 41, 46 press against the component 3 from below and remove it at least partially from the receiving apparatus 40. It is apparent that in the unactuated state (FIG. 1), the segments 44, 45 are already inclined relative to one another and to the direction of action A of the force on the actuation surface 40. This angle of inclination increases over the course of the actuation during the triggering operation, as shown in FIG. 2.

In one advantageous embodiment, the first segment 43 is articulatedly connected to the second segment 44 via a hinge 47. The second segment 44 may be articulatedly connected to the third segment 45 via a hinge 48. The hinges 47, 48 may be designed, for example, as film hinges, for example by manufacturing them as an integrally joined material bridge between the particular segments. The entire trigger pusher 4 may thus be manufactured in the form of a single structural unit, for example as a plastic part in an injection molding process.

FIG. 3 shows the trigger pusher 4 of the electrical device 1 as an individual component, thus further clarifying the structure of the trigger pusher 4.

The electrical device 1 may also have multiple receiving apparatuses for accommodating multiple electrical and/or electronic components. To enable a triggering operation for these multiple components, the electrical device may also have multiple trigger units or multiple trigger pushers 4. The multiple receiving apparatuses may be situated next to one another in a direction parallel to the first and second housing sides 21, 22, or may also be situated, in whole or in part, one behind the other, viewed from the second housing side 22.

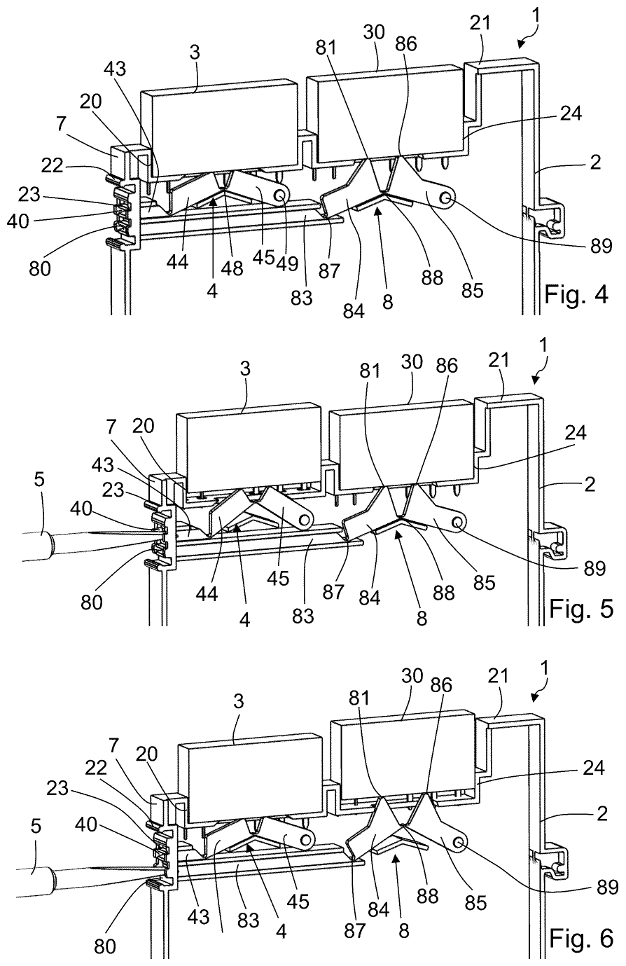

FIGS. 4 through 6 show an embodiment of the electrical device 1 in which in addition to the receiving apparatus 20, a further receiving apparatus 24 for accommodating a further electrical and/or electronic component 30 is present. The further receiving apparatus 24 is situated completely behind the receiving apparatus 20, viewed from the second housing side 22. A trigger unit with a trigger pusher 4, which may be designed as in FIGS. 1 and 2, is once again associated with the receiving apparatus 20, similarly as described for FIGS. 1 and 2.

Also present is a further trigger unit with a further trigger pusher 8 that is used to perform a triggering operation on the further component 30. The basic design of the further trigger pusher 8 is comparable to that of the trigger pusher 4, except that its dimensions are adapted to the positioning of the further receiving apparatus 24 farther to the rear. For this purpose a first segment 83 of the further trigger pusher 8, which has an actuation surface 80 in the area of the second housing side 22, is significantly longer than the first segment 43 of the other trigger pusher 4. The first segment 83 extends below and along the trigger pusher 4 up to a second segment 84 of the further trigger pusher 8. The second segment 84 is adjoined by a third segment 85 of the further trigger pusher 8. The second segment 84 and the third segment 85 have a similar design to the second and third segments of the other trigger pusher 4, except that the installation height of the latter is slightly increased to compensate for the height difference between the first segments 43, 83. The third segment 85 may be swivelably supported on a swivel bearing 89. The first segment 83 may be connected to the second segment 84 via a hinge 87. The second segment 84 may be connected to the third segment 85 via a hinge 88. The hinges 87, 88 may be designed as film hinges, for example by manufacturing them as an integrally joined material bridge between the particular segments.

At the end facing away from the first segment 83, the second segment 84 has an end section 81, which during the triggering operation presses against the component 3 to be ejected. This end section 81 is also referred to as a plunger. The third segment 85 has a comparable section 86 which during the triggering operation comes into contact with the component 3 to be ejected. In an area remote from the section 86, the third segment is swivelably supported, for example via a swivel bearing 89.

FIG. 4 shows the electrical device 1 in a state in which both trigger pushers 4, 8 are unactuated. In FIG. 5, the trigger pusher 4 is actuated by a force that is exerted on the actuation surface 40 via the tool 5. In FIG. 6, the further trigger pusher 8 is actuated via a force that is exerted by the tool 5 on the actuation surface 80 of the further trigger pusher. It is apparent that the further component 30 is thus at least partially pushed out of the further receiving apparatus 24.

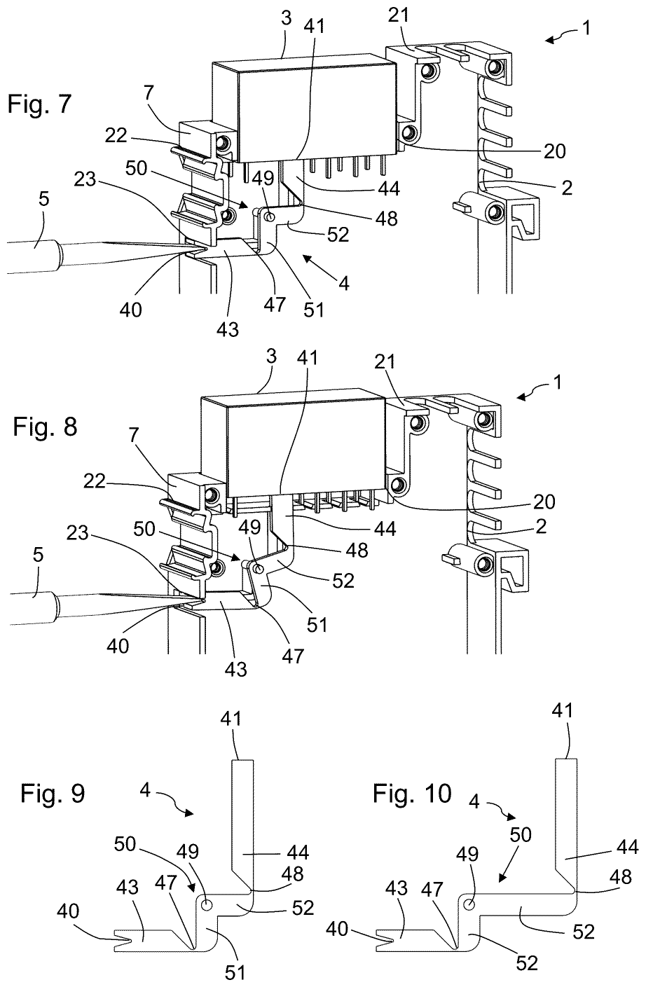

With reference to FIGS. 7 through 10, a further advantageous embodiment of a trigger pusher 4 is described, which includes a swivelably supported deflection lever 50 for bringing about the deflection from the direction of action A into the direction of action B. The trigger pusher 4 once again has a first segment 43 at which the actuation surface 40 is present in the area of the opening 23 or at the second housing side 22. In the kinematic chain here, the first segment 43 is adjoined by the mentioned deflection lever 50. The deflection lever 50 is adjoined by a second segment 44 of the trigger pusher 4. Via the second segment 44 or its end section 41, the component 3 may be at least partially pushed out of the receiving apparatus 20 by exertion of a force, for example a pressure force, on the actuation surface 40.

The deflection lever 50 may be swivelably supported on a swivel bearing 49. The first segment 43 may be connected to a lever arm of the deflection lever 50 via a hinge 47. The other lever arm of the deflection lever 50 may be connected to the second segment 44 via a hinge 48. The hinges 47, 48 may be designed as film hinges, for example by manufacturing them as an integrally joined material bridge between the particular segments and the deflection lever 50.

FIG. 7 shows the trigger pusher in the unactuated state. In FIG. 8 the trigger pusher is actuated by a force that is exerted on the actuation surface 40 via the tool 5, so that a corresponding force is exerted against the component 3 from below in order to at least partially push the component out of the receiving apparatus 20.

By use of such a deflection lever 50, different force transmission ratios or travel transmission ratios may advantageously be selectively achieved with little technical effort, as illustrated by FIGS. 9 and 10. FIG. 9 shows a deflection lever 50 in which the force arm 51 on which the first segment 43 acts has the same length as the load arm 52, via which the second segment 44 is movable. In FIG. 10 the load arm 52 is much longer than the force arm 51. In this way a large actuating travel may be achieved at the second segment 44 with a small actuating travel of the first segment 43.

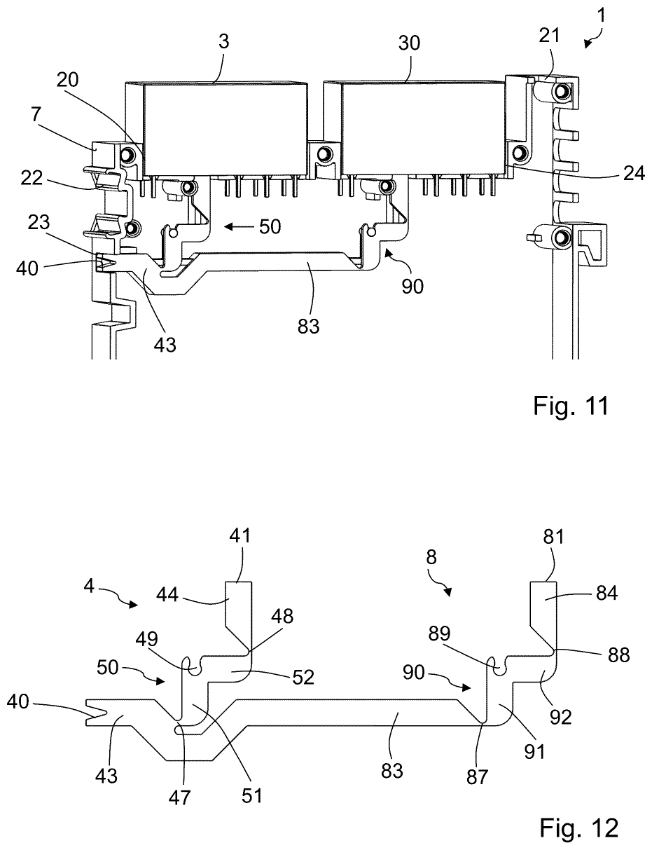

The above-described deflection lever principle may also be used in embodiments in which, similarly to FIGS. 4 through 6, the electrical device 1 has multiple receiving apparatuses 20, 24. This is explained by way of example with reference to the embodiments illustrated in FIGS. 11 and 12. It is apparent that the trigger pusher 4 is designed as a structural unit that is integrated with the elements of a further trigger pusher 8. The components may also be designed separately as a trigger pusher 4 and a further trigger pusher 8, and may be mechanically connected to one another. In any case, both trigger pushers 4, 8 or their mechanisms may be manually actuated via a shared actuation surface 40.

It is apparent that with regard to the deflection lever 50 which is connected to the first segment 43, the trigger pusher 4 has a design that is comparable to the trigger pusher according to FIG. 9 or FIG. 10. In addition, a first segment 83 of the further trigger pusher 8 is directly attached to the first segment 43, for example molded thereon in one piece. A further deflection lever 90 is attached to the first segment 83 of the further trigger pusher 8 via a hinge 87, for example. The further deflection lever 90 may have a design that is comparable to the deflection lever 50, for example with a force arm 91 and a load arm 92. The further deflection lever 90 may be swivelably suspended via a swivel bearing 89. The second segment 84 of the further trigger pusher 8, at which the end section 81 provided at the free end for pushing out the further component is situated, is attached to the further deflection lever 90 via the hinge 88. When a pressure force is exerted on the actuation surface 40, both levers 50, 90 are swiveled, and both components 3, 30 are removed from the respective receiving apparatuses 20, 24 via the respective end sections 41, 81.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. An electrical device comprising:
a receiving apparatus to releasably accommodate an electrical and/or electronic component;
a housing; and
a trigger unit to perform a triggering operation on the electrical and/or electronic component, the trigger unit having a trigger pusher that has an actuation surface for actuating the trigger pusher,
wherein, during a triggering operation, the electrical and/or electronic component, by actuation of the actuation surface, is at least partially removable from the receiving apparatus as a result of a force exerted on the component by the trigger pusher, and
wherein the electrical and/or electronic component is insertable into the receiving apparatus from a first housing side of the housing of the electrical device, and via the actuation, the actuation surface is actuatable from a second housing side of the housing of the electrical device.

2. The electrical device according to claim 1, wherein the second housing side is a housing side of the housing of the electrical device facing away from the first housing side or situated at an angle thereto.

3. The electrical device according to claim 1, wherein as a result of the trigger pusher, during a triggering operation on the component, a force applied to the actuation surface in a first direction is deflected into a force that acts in a second direction on the component to be ejected, the first direction differing from the second direction.

4. The electrical device according to claim 3, wherein an angle in the range of 45° to 135°, or an essentially right angle, is formed between the first direction and the second direction.

5. The electrical device according to claim 1, wherein the trigger pusher has at least one first segment and one second segment, wherein the first segment includes the actuation surface and the second segment includes a section or an end-side section, which during the triggering operation comes into contact with the component to be ejected.

6. The electrical device according to claim 5, wherein the first segment and the second segment are articulatedly connected to one another via at least one hinge.

7. The electrical device according to claim 5, wherein the first segment is coupled to the second segment via a swivelably supported deflection lever.

8. The electrical device according to claim 5, wherein the trigger pusher has at least one third segment that is articulatedly connected to the second segment via at least one hinge.

9. The electrical device according to claim 5, wherein the trigger pusher has at least one third segment that is swivelably supported on a swivel bearing at an area facing away from the second segment.

10. The electrical device according to claim 1, wherein the electrical device has a further receiving apparatus tor releasably accommodate a further electrical and/or electronic component, in particular a relay module or an electrical circuit, the electrical device having a further trigger unit for performing a triggering operation on the further component, the further trigger unit including a further trigger pusher that has an actuation surface for actuating the further trigger pusher, wherein during a triggering operation the further component, by actuation of the actuation surface, is at least partially removable from the further receiving apparatus as a result of a force exerted on the component by the further trigger pusher, and wherein via the actuation the actuation surface is actuatable from the second housing side of the housing of the electrical device.

11. The electrical device according to claim 10, wherein the further receiving apparatus is situated farther away from the second housing side than the receiving apparatus, or is situated behind the receiving apparatus as viewed from the second housing side.

12. The electrical device according to claim 1, wherein at its end facing away from the actuation surface, the trigger pusher has an end section that forms a plunger, via which the component is at least partially removable from the receiving apparatus.

13. The electrical device according to claim 1, wherein the component is insertable into the receiving apparatus only from the first housing side.

14. The electrical device according to claim 1, wherein the actuation surface is actuatable by the actuation only from the second housing side.

15. The electrical device according to claim 1, wherein at the second housing side the housing has an opening through which the trigger pusher is actuatable at its actuation surface and/or through which the trigger pusher protrudes from the housing.

16. The electrical device according to claim 1, wherein the electrical or electronic component is a relay module or an electrical circuit.
